(19) United States
(12) Patent Application Publication
(10) Pub. No.: US 2005/0055424 A1
(43) Pub. Date: Mar. 10, 2005

(54) Read-only baseline web site to which changes are made via mirror copy thereof in cut-and-paste manner

(75) Inventor: Thomas W. Smith, Fredericksburg, VA (US)

Correspondence Address: Matthew J. Bussan, Esq., NSWCDD (XDC1), Dahlgren, VA, 22448-5100, US

(73) Assignee: Government of the United States of America as represented by the Secretary of the Navy.

(21) Appl. No.: 10/658,896

(22) Filed: Sep. 10, 2003

(51) Int. Cl. G06F 15/16

(52) U.S. Cl. 709/219; 709/229

(57) ABSTRACT

A system is disclosed that includes a baseline web site that is primarily and ordinarily read-only. The baseline web site has a number of web pages. The web pages are remotely accessible by authorized users through a network, via client communication devices communicatively coupled to the network. A mirror web site that is initially a mirror copy of the baseline site is remotely accessible, by the authorized users via the client communication devices communicatively coupled to the network. A web application running on the mirror site accepts user-made changes to the mirror copy of the baseline site in a cut-and-paste manner. Administrators authorize the user-made changes, so the baseline site is periodically updated from the mirror site.

### BACKGROUND OF THE INVENTION

Situation, or War, Rooms, are frequently used in a variety of different military and corporate settings. Rather than having important personnel scattered about different locations during an important situation, and rather than using a makeshift conference or other room on a temporary basis, a Situation or War Room is used as a common gathering point for personnel to discuss options and view status updates and other information. Because such rooms are usually dedicated to this purpose, they can be equipped with a sufficient amount of communication and other equipment for the users.

In the past, large blackboards, whiteboards, and other type of boards were placed on the walls of Situation or War Rooms. These boards enabled all personnel within the room to see current information, without having to provide individual copies of the information to each user. When updating the information was required, either a board was taken down and a new board was put up in its place, or the information on a given board was erased and the updated information written in its place. Because updating required manual effort, diligence was needed to ensure that the boards remained current.

As technology has become more invasive, these manual boards have since been replaced by screens. The screens may display different television channels, for instance, or be connected to computers to display information for all personnel within the room to see. However, even though computerized displays afford faster updating of the information, many personnel are not advanced computer users, and have difficulty providing the displays with the information that they want everyone else to see. As a result, computer technicians may be needed to update the displays.

Furthermore, although it is ideal that all personnel remain in the Situation or War Room to view the information and discuss it with other users, in actuality some personnel may have to be absent from the room. Other situations may require that personnel be traveling, or personal or health conditions may prevent the personnel from visiting the room. Whatever the reason, such users are at a disadvantage because they are not able to view the information that others within the room can. If the absent users are important decision makers, this can affect the resolution of the situation that is the reason users are congregating in the room in the first place.

Indeed, many Situation or War Rooms are completely virtual in nature. This means that there may be no physical room in which occupants congregate for viewing and discussing information. Rather, all of the information is presented in an online, computerized manner for access by the participants. However, virtual Situation or War Rooms can be technologically complex, especially to update or change the information that is presented to the participants. As a result, some users may be less inclined to use online technologies, because they do not know how, or are unable to learn how, to update content available in a virtual manner.

For these and other reasons, there is a need for the present invention.

### SUMMARY OF THE INVENTION

A system of the invention includes a baseline web site that is primarily and ordinarily read-only. The baseline web site has a number of web pages. The web pages are remotely accessible by authorized users through a network, via client communication devices communicatively coupled to the network. A mirror web site that is initially a mirror copy of the baseline web site is remotely accessible by the authorized users through the network via the client communication devices communicatively coupled to the network. A web application running on the mirror web site accepts user-made changes to the mirror copy of the baseline web site in a cut-and-paste manner. Administrators are able to authorize the user-made changes, such that the baseline web site is periodically updated from the mirror web site.

Embodiments of the invention provide for advantages over the prior art. Users are able to remotely access the baseline web site Personnel are easily able to change or update the pages of the baseline web site by, for instance, cutting and pasting from other applications running on a computing device to the mirror copy of the baseline web site. To ensure that spurious, out-of-date, or irrelevant information is not posted to the web site, the baseline web site that is viewable by everyone remains read only and is not directly changed by users cutting and pasting information from other applications. Rather, an administrator authorizes the user-made changes so that they are copied from the mirror site to the baseline site.

Still other aspects, embodiments, and advantages of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not all embodiments of the invention, unless otherwise explicitly indicated, and implications to the contrary are otherwise not to be made.

FIG. 1 is a diagram of an example Situation or War Room, according to an embodiment of the invention.

FIG. 2 is a diagram of a system, including a baseline web site and a mirror web site, according to an embodiment of the invention.

FIG. 3 is a diagram showing how the baseline web site can be modified by making changes to the mirror web site in a cut-and-paste manner, and then updating the baseline web site from the mirror web site, according to an embodiment of the invention.

FIG. 4 is a flowchart of a method for updating a baseline web site through a mirror copy of the site, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized and logical, mechanical, and other changes may be made without departing from the spirit or scope of the present invention. For example, whereas the invention is substantially described in relation to a ship, it is applicable to other types of vehicles as well. The following detailed description is, therefore, not to be taken in a limiting sense, and the scope of the present invention is defined only by the appended claims.

Embodiments of the invention are amenable to implementation in conjunction with partially virtual, or completely virtual, Situation or War Rooms. Therefore, the Situation or War Rooms that are at least partially physical and that are described herein pertain to only some, and not all, embodiments of the invention. Other embodiments of the invention are applicable to War or Situation Rooms that are completely virtual, in that there is not a physical place at which participants congregate. Rather, all information access and updating is accomplished online, from client devices communicating over a network on which the virtual room is maintained.

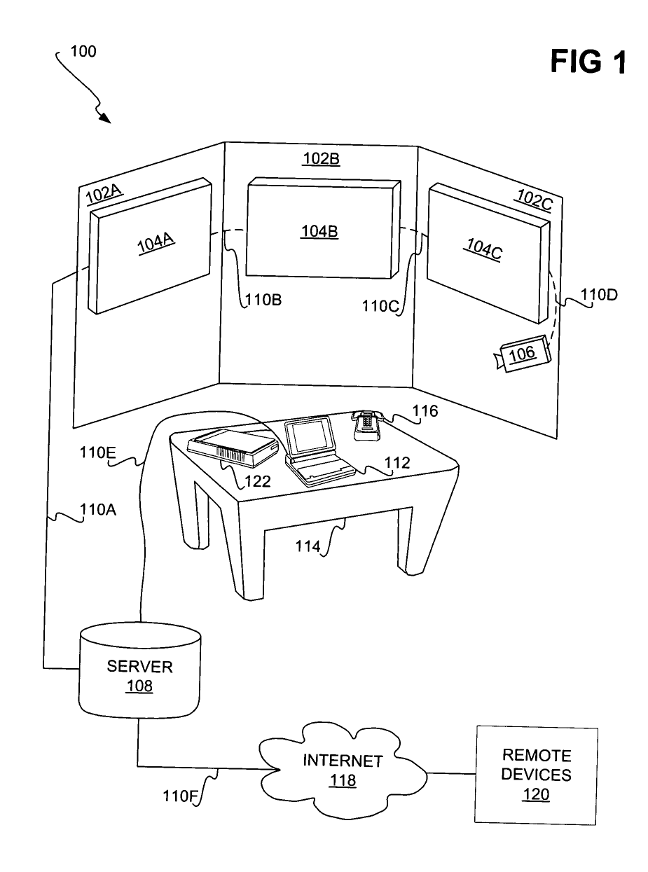

Therefore, FIG. 1 shows a representative physical Situation or War Room 100, according to one embodiment of the invention. The room includes a number of walls 102A, 102B, and 102C, collectively referred to as the walls 102. Large, wall-mountable displays 104A, 104B, and 104C, collectively referred to as the displays 104, are mounted on the walls 102. The displays 104 are preferably sufficiently large such that multiple users within the room 100 can view the displays 104 from any location within the room 100 at the same time. The displays 104 may be liquid crystal displays (LCD's), plasma displays, other types of flat-panel displays, cathode-ray tube (CRT) displays, or other types of displays. A video camera 106 is also mounted on the wall 102C.

On a large conference-type table 114 in the center of the room 100, there can be communication equipment, such as a telephone 116. Other client communication devices include a laptop or notebook computer 112, as well as other types of computing devices, such as personal digital assistant (PDA) devices, handheld computing devices, desktop computing devices, mobile phones, special-purpose devices, and other types of host computing devices. These devices are communication devices in that they are communicatively coupled to a server 108 via a network 110 having at least constituent network parts 110A, 110B, 110C, 110D, 110E, and 110F. The displays 104 and the video camera 106 are also communicatively coupled to the network 110 and thus to the server 108. A scanning device 122 further resides on the table 114, and is communicatively connected to the network 110.

Information stored on the server 108 is displayable locally within the room 100 on the displays 104, as well as on the computer 112. Information from the computer 112 may be transferred to the server 108 so that it can be displayed on the displays 104. Similarly, hardcopy media information may be scanned in via the scanning device 122 and stored on the server 108 so that it can be displayed on the displays 104. Information scanned in via the scanning device 112 may be uploaded as a scanned data set, or may be transferred electronically as a file or a correction to existing data. The video camera 106 may be used for videoconferencing purposes with respect to the personnel in the room 100. The video camera 106 may also record videos that are stored on the server 108, for presentation on the displays 104. The remote personnel with whom the videoconferences are occurring may be presented on the displays 104 as well.

For remote personnel to be able to view the information that is presented on the displays 104, the server 108 is communicatively coupled to the Internet 118 via the network part 110F. The network 110 can be said to include a local-area network (LAN), a wide-area network (WAN), a virtual private network (VPN), an intranet, an extranet, the Internet, a wired network, and/or a wireless network. The remote personnel employ remote communication devices 120 to be able to view information stored on the server 108. Furthermore, the remote personnel may transfer information to the server 108 in a manner similar to the way local personnel do, so that such information may be viewed by other remote users, and the local users within the room 100.

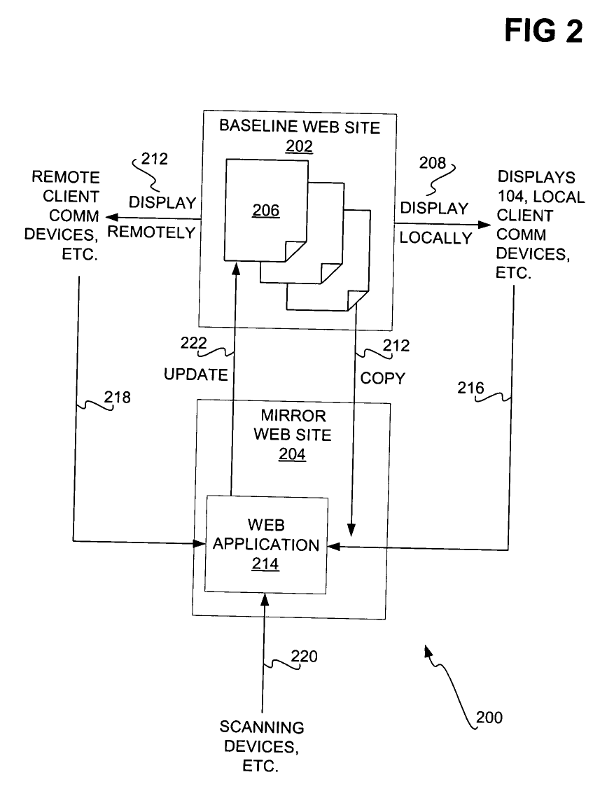

FIG. 2 shows a system 200, according to an embodiment of the invention. The system 200 can be utilized in conjunction with the Situation or War Room 100 of FIG. 1. The system 200 may also be utilized in conjunction with a completely virtual Situation or War Room, which does not have a physical place at which participants congregate. Furthermore, besides those components depicted in FIG. 2, the system 200 can include the various displays, servers, communication devices, and other devices depicted in FIG. 1. The system 200 in FIG. 2 is shown as including a baseline web site 202 and a mirror web site 204. The web sites 202 and 204 may be hosted by the same server 108 of FIG. 1. Alternatively, the sites 202 and 204 may be hosted by different servers. A web site is a collection of web pages formatted in a manner that are accessible via a web-browsing program, and that are commonly accessed over the Internet.

The baseline web site 202 has a number of web pages 206. The baseline web site 202 and the mirror web site 204 may share a common home page, or may have different home pages. A home page is the first page retrieved when accessing a web site. Preferably, the home page(s) of the web sites 202 and 204 are accessible in a secure manner, such as by using a secure socket layer (SSL). This means that the home page is not usually retrievable by search engines, maintaining the confidentiality of the web sites 202 and 204. The secure manner may also be used to access all the pages of the web sites 202 and 204, and passwords or other types of authorization may be employed to further restrict access to the sites 202 and 204. Thus, the sites 202 and 204 are regulated by secure network connections through a network, such as the network 110 of FIG. 1. The home page(s) of the sites 202 and 204 include hyperlinks from which other web pages of the web sites 202 and 204 are accessible.

The baseline web site 202 is primarily and ordinarily read-only, in that its pages 206 are not ordinarily modifiable by personnel viewing them. The web site 202 is for primary display locally on the displays 104 of FIG. 1, as well as the client communication devices located within the room 100 of FIG. 1, as indicated by the reference number 208. Furthermore, the web site 202 may be viewed or displayed remotely, outside of the room 100, on remote client communication devices over the Internet. Both remote and local displaying and viewing of the web site 202 may be accomplished via the network 110 of FIG. 1. The web site 202 thus affords remote personnel the ability to view the same information as the personnel residing within the room 100 can view.

So that personnel can make changes to the baseline web site 202, the web pages 206 thereof are copied to the mirror web site 204, as indicated by the arrow 212. A web application 214, written in or using Java, ActiveX, or another type of programming language or web enablement software technology enables user-made changes to the mirror copy of the baseline web site 202, as residing on the mirror web site 204, to be accepted in a cut-and-paste manner. Users can therefore suggest changes that should be made to the baseline web site 202, without having to have any extraordinary computer skills.

Local users can make such modifications to the mirror web site 204, as indicated by the arrow 216, as well as remote users, as indicated by the arrow 218. Furthermore, scanning devices can be used to make modifications to the web site by scanning in information from non-electronic, hardcopy media, as indicated by the arrow 220, such as books, magazines, paper, and so on, resulting in scanned-in information. Information scanned in via scanning devices may be uploaded as a scanned data set, or may be transferred electronically as a file or a correction to existing data. Cut and paste encompasses copy and paste, and generally refers to the moving of data from one application to another, by selecting the data in the first application, copying or cutting the data to a clipboard, which is a temporary storage location for the data, and then pasting the data from the clipboard to the second application. Nearly all graphical-based operating systems have user interfaces that support cut-and-paste capabilities.

The changes that have been made to the mirror web site 204 are periodically reviewed by one or more administrators, who are users authorized to make changes to the baseline web site 202. Once an administrator has approved a particular modification to the mirror web site 204, the baseline web site 202 can be updated to include this information, as indicated by the arrow 222. Thus, the baseline web site 202 is periodically updated from the mirror web site 204.

Having a central point at which suggested changes to the baseline web site 202, via corresponding changes to the mirror web site 204 are approved ensures that duplicate, outdated, spurious and other types of unwanted information do not find their way onto the baseline web site 202. The modifications made to the mirror web site 204 for updating the baseline web site 202 can include additional information to that which is already on the baseline site 202. The modifications may also include replacement information to that which is already on the baseline site 202.

The web pages 206 of the baseline web site 202 have thus far been described as including information for primary display on the displays 104 on the walls 102 of the room 100 of FIG. 1. However, the web pages 206 may include other information not intended or meant for primary display on the displays 104. For instance, a subset of the web pages 206 may serve as electronic notebooks. Information contained within the electronic notebooks may be related to and support the web pages 206 that are to be primarily displayed on the displays 104.

The electronic notebooks may be accessible by different authorized users having different levels of access according to them. For instance, information may be compartmentalized, so that different users have different access to different types of information. As another example, the levels of access may be hierarchical in nature, such that a higher level of access affords the ability to review all the information that a lower level of access has the ability to review, plus information that the lower level of access cannot review.

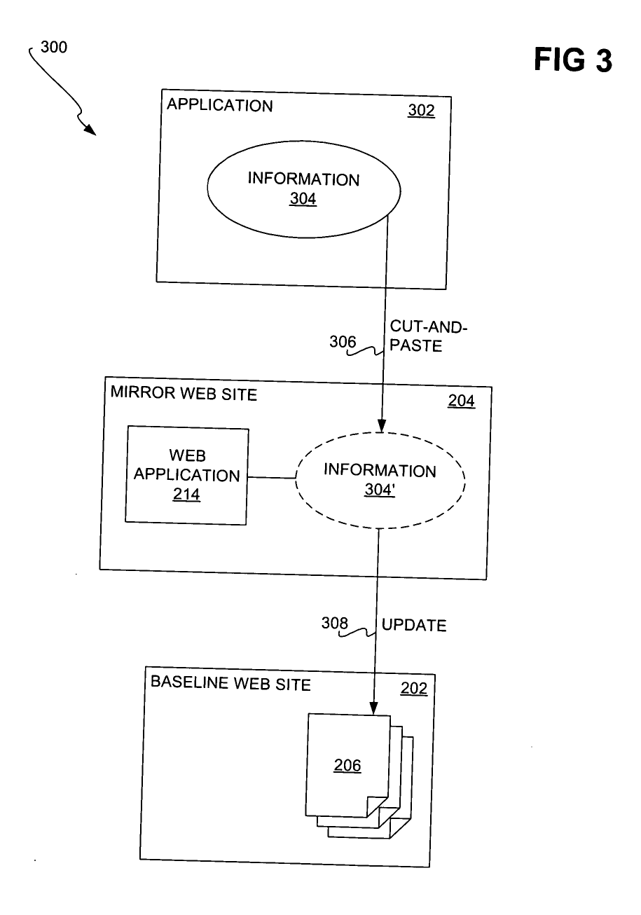

FIG. 3 shows a representative scenario 300 that depicts in greater detail how changes to the baseline web site 202 are made via the web application 214 of the mirror web site 204 in a cut-and-paste manner, according to an embodiment of the invention. An application program 302 runs on a remote or local client communication device. The application program 302 contains information 304 with which an authorized user wishes to update the baseline web-site 202. The program 302 may be a word processing program, a spreadsheet application program, an email communication program, a graphics program, a web browsing program, a scheduling program, a presentation program, a streaming video and/or clip program, or other types of commercial and other application programs, as needed by users, where application reader programs, such as Adobe Acrobat Reader, available from Adobe Systems, Inc. of San Jose, Calif., may be downloaded from web page links or directly from a server.

The user cuts and pastes the information 304 from the application 302 to the mirror web site 204, as enabled by the web application 214, as indicated in FIG. 3 via the arrow 306, resulting in the information 304′. As has been noted, cut and paste can include copy and paste as well. The information 304 may include replacement or additional data to that already stored on the baseline web site 202. The information 304 may include textual information, graphical information, or other type of information.

At some point, an authorized administrator reviews the information 304′ that has been pasted to the mirror web site 204, via the web application 214. If the administrator approves the information 304 for copying back to the baseline web site 202, then the administrator issues an update command to the web application 214, which updates the web pages 206 of the baseline web site 202 with the information 304, as indicated by the arrow 202. The baseline web site 202 is thus updated in this manner by users through the mirror web site 204.

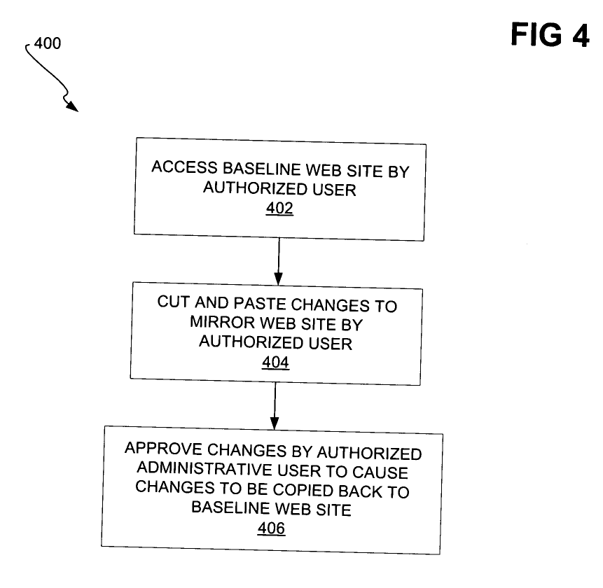

FIG. 4 shows a method 400 that summarizes the update process of the baseline web site 202 described in relation to FIG. 3, according to an embodiment of the invention. An authorized user accesses the baseline web site 202, which has the web pages 206 (402). For instance, the authorized user may view the web site 202 on one of the displays 104 on the walls 102 of the room 100 of FIG. 1, where the room preferably has restricted access to only authorized personnel. Alternatively, the authorized user may view the baseline web site 202 remotely, through the network 110 via a client communication device communicatively coupled to the network 110.

The authorized user then cuts and pastes changes to the mirror web site 204, via the web application 214 running on the web site 204 (404). The mirror web site is initially a mirror copy of the baseline web site 202. The user may cut and paste additional and replacement data from an application program running on the client communication device communicatively coupled to the network 110, to the web application 214 of the mirror web site 204.

Periodically an authorized administrative user approves or rejects the changes made to the mirror web site 204 (406). Assuming that the changes are approved, they are copied back to the baseline web site 202, to update the baseline web site 202. The mirror web site 204 is thus again a mirror copy of the baseline web site 202, and further changes can be made to the mirror copy of the web site 202. As before, these further changes, if approved, are then copied back to the baseline web site 202.

It is noted that, although specific embodiments have been illustrated and described herein, it will be appreciated by those of ordinary skill in the art that any arrangement is calculated to achieve the same purpose and may be substituted for the specific embodiments shown. For example, other applications and uses of embodiments of the invention, besides those described herein, are amenable to at least some embodiments. This application is intended to cover any adaptations or variations of the present invention. Therefore, it is manifestly intended that this invention be limited only by the claims and equivalents thereof.

1. A system comprising:
a baseline web site that is primarily and ordinarily read-only, having a plurality of web pages being remotely accessible by authorized users through a network via client communication devices communicatively coupled to the network;
a mirror web site that is initially a mirror copy of the baseline web site and that is remotely accessible by the authorized users through the network via the client communication devices communicatively coupled to the network; and,
a web application running on the mirror web site to accept user-made changes to the mirror copy of the baseline web site in a cut-and-paste manner, one or more administrators being able to authorize the user-made changes such that the baseline web site is periodically updated from the mirror web site.

2. The system of claim 1, wherein the web application is receptive to additional and replacement data serving as the user-made changes to the mirror copy of the baseline web site in the cut-and-paste manner from other applications running on the client communication devices.

3. The system of claim 2, wherein the other applications running on the client communication devices comprise one or more of: word processing application programs, spreadsheet application programs, email communication application programs, graphics application programs, scheduling application programs, presentation application programs, streamlining video and/or clip application programs, and web browsing application programs.

4. The system of claim 2, wherein the additional and replacement data comprises scanned-in information from non-electronic, hardcopy media.

5. The system of claim 1, wherein the baseline web site and the mirror web site each have a home web page that is regulated by a secure network connection through the network and from which other web pages on the web site are accessible via hyperlinks.

6. The system of claim 1, wherein the baseline web site and the mirror web site share a common home page that is regulated by a secure network connection through the network and from which other web pages on the web site are accessible via hyperlinks.

7. The system of claim 1, wherein the baseline web site further has a plurality of second web pages to serve as electronic notebooks containing information related to and supporting the plurality of web pages, different of the plurality of second web pages accessible by different of the authorized users via different levels of access accorded to different of the authorized users.

8. The system of claim 1, further comprising the plurality of wall-mountable, multiple user-viewable displays for mounting on the walls of the room.

9. The system of claim 1, further comprising at least one server to host at least one of the baseline web site and the mirror web site, each server communicatively coupled to the network.

10. The system of claim 1, further comprising at least some of the client communication devices.

11. The system of claim 1, wherein the client communication devices comprise one or more of: a computing device, a desktop computing device, a laptop computing device, a handheld computing device, a mobile phone, and a special-purpose device.

12. The system of claim 1, wherein the network comprises one or more of: the Internet, an intranet, an extranet, a virtual private network (VPN), a local-area network (LAN), a wide-area network (WAN), a wired network, and a wireless network.

13. The system of claim 1, wherein the baseline web site is for primary display on a plurality of wall-mountable, multiple-user-viewable displays for mounting on walls of a room, the baseline web site and the mirror web site locally accessible within the room.

14. A system comprising:
a plurality of wall-mountable, multiple user-viewable displays for mounting on walls of a room;
at least one server to host a baseline web site and a mirror web site, each server communicatively coupled to a network,
the baseline web site being primarily and ordinarily read-only, and having a plurality of web pages for primary display on the plurality of wall-mountable, multiple user-viewable displays, the plurality of web pages being remotely accessible outside of the room by authorized users through the network via client communication devices communicatively coupled to the network,
the mirror web site being initially a mirror copy of the baseline web site and locally accessible within the room and remotely accessible outside of the room by the authorized users through the network via the client communication devices communicatively coupled to the network; and,
a web application running on the mirror web site to accept user-made changes to the mirror copy of the baseline web site in a cut-and-paste manner, one or more administrators being able to authorize the user-made changes such that the baseline web site is periodically updated from the mirror web site,
the web application receptive to additional and replacement data serving as the user-made changes to the mirror copy of the baseline web site in the cut-and-paste manner from other applications running on the client communication devices.

15. The system of claim 14, further comprising one or more scanning devices locatable within the room to generate scanned-in information from non-electronic hardcopy media as the additional and replacement data.

16. The system of claim 14, further comprising at least some of the client communication devices locatable within the room.

17. A method comprising:
accessing by an authorized user a baseline web site having a plurality of web pages through a network;
cutting and pasting changes by the authorized user to a mirror web site that is initially a mirror copy of the baseline web site via a web application running on the mirror web site; and,
approving the changes by an authorized administrative user to cause the changes to be copied back to the baseline web site.

18. The method of claim 17, wherein accessing by the authorized user of the baseline web site comprises viewing the baseline web site on one of a plurality of multiple user-viewable displays mounted on walls of a room having restricted access, the displays communicatively coupled to the network.

19. The method of claim 17, wherein accessing by the authorized user of the baseline web site comprises remotely accessing the baseline web site through a network via a client communication device communicatively coupled to the network.

20. The method of claim 17, wherein cutting and pasting the changes by the authorized user to the mirror web site comprises cutting and pasting additional and replacement data from an application running on a client communication device communicatively coupled to the network to the web application.
